(19) United States
(12) Patent Application Publication
(10) Pub. No.: US 2025/0180070 A1
(43) Pub. Date: Jun. 5, 2025

(54) POLYCRYSTALLINE DIAMOND BEARINGS IN AN RCD

(71) Applicant: Hydril USA Distribution LLC, Houston, TX (US)

(72) Inventors: Hunter S. Haeberle, Houston, TX (US); Kevin M. Sweeney, Houston, TX (US); David Andrew Wallace, Houston, TX (US); Manuel Garibay, Houston, TX (US); Katie A. Kotarek, Houston, TX (US)

(73) Assignee: Hydril USA Distribution LLC, Houston, TX (US)

(21) Appl. No.: 18/962,865

(22) Filed: Nov. 27, 2024

Related U.S. Application Data
(60) Provisional application No. 63/604,588, filed on Nov. 30, 2023.

(51) Int. Cl. F16C 33/04; E21B 4/00

(52) U.S. Cl. CPC F16C 33/043; E21B 4/003; F16C 2352/00

(57) ABSTRACT

Rotating control devices (RCDs) include one or more polycrystalline diamond (PCD) bearings positioned between an inner housing and an outer housing of the RCD, where the inner housing and outer housing are rotatable relative to each other along a rotational axis via the PCD bearings.

### RELATED APPLICATIONS

This application claims priority to U.S. Provisional Application No. 63/604,588, filed on Nov. 30, 2023, the entire contents of which are incorporated herein by reference.

### BACKGROUND

Rotating control devices (RCDs) are used to contain and redirect annular flow of fluids through a well. When installed, the RCD seals around a rotating drill pipe. One or more controlled flowlines may be provided below the seal, through which fluids from the well may be diverted.

FIG. 1 shows an example of a generic RCD 100 mounted at the top side of a blowout preventer (BOP) 110, for use in one or more operations of a well 101. The RCD 100 includes an outer housing 102 that may be bolted to the BOP 110 or other connecting component. The RCD further includes an inner rotating housing 104 rotatably mounted within the outer housing 102 using one or more bearing assemblies, which typically include roller-type bearings. One or more sealing elements 106 are connected to the inner rotating housing 104. The sealing elements 106 contact and seal against drill pipe 120 as the drill pipe 120 is extended into and rotated within the well 101. With the drill pipe 120 inserted through the RCD 100, the drill pipe 120 may be rotated by a Kelly or other assembly, where rotation of the drill pipe 120 may in turn rotate the inner housing 104 through sealing connection between the sealing elements 106.

### BRIEF DESCRIPTION OF DRAWINGS

Wherever possible, like or identical reference numerals are used in the figures to identify common or the same elements. The figures are not necessarily to scale and certain features and certain views of the figures may be shown exaggerated in scale for purposes of clarification.

FIG. 1 shows a typical well system utilizing an RCD.

FIG. 2 shows an RCD according to embodiments of the present disclosure.

FIGS. 3A-B show radial and axial PCD bearings according to embodiments of the present disclosure.

FIG. 4 shows another example of an RCD according to embodiments of the present disclosure.

FIG. 5 shows another example of an RCD according to embodiments of the present disclosure.

### DETAILED DESCRIPTION

Embodiments disclosed herein relate generally to rotating control devices (RCDs) that include one or more polycrystalline diamond (PCD) bearings. Embodiments disclosed herein also relate to methods for providing rotation to an RCD system by use of the one or more PCD bearings. The PCD bearings may be arranged to provide support for radial loads through radial PCD bearings, for axial loads through axial PCD bearings, and/or for radial and axial loads through tapered PCD bearings.

RCDs generally include an outer housing, and an inner housing rotationally held within the outer housing. An annular sealing element, such as any sealing element known in the industry, may be connected to the inner housing in a position that allows the sealing element to contact and seal around a drill string or other piping that is inserted through the RCD. For example, in some RCDs, an annular sealing element may have a tapered body made of a rubber, rubber composite, or other resilient elastomeric material so when downhole pressure pushes up on the sealing element body, the sealing element body presses against the drill string to achieve a fluid-tight seal. In some RCDs, an annular sealing element may have a rubber or elastomeric body in the shape of a sleeve, which may be squeezed around the drill string to achieve a fluid-tight seal. Various types of annular sealing elements for sealing around a drill string may be used in various types of RCDs, which are not limited for use with PCD bearings according to embodiments of the present disclosure.

When piping is inserted through an annular sealing element in an RCD, the grip between the sealing element and the piping may allow rotation of the sealing element with the piping, and thus also rotation of the connected inner housing with the sealing element. Thus, in operation, an assembly of an inner housing, one or more connected annular scaling elements, and a piping sealed by the sealing elements is rotatable in the outer housing. According to embodiments of the present disclosure, one or more PCD bearings are provided between the inner housing and the outer housing of an RCD to allow rotation of the inner housing relative to the outer housing.

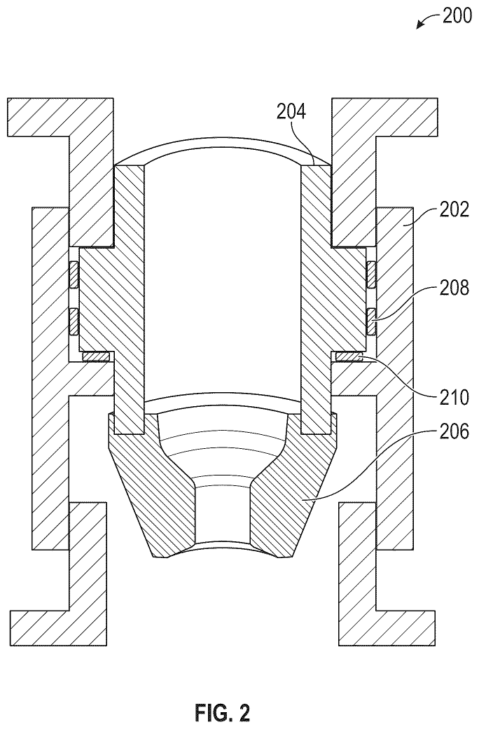

A generic RCD system is shown in FIG. 2 in order to demonstrate the use of PCD bearings according to embodiments of the present disclosure. However, one of ordinary skill in the art may appreciate that PCD bearings according to embodiments of the present disclosure may be provided in other types of RCD systems, e.g., RCD systems having multiple sealing elements, RCD systems having pressure-activated annular sealing elements, and others.

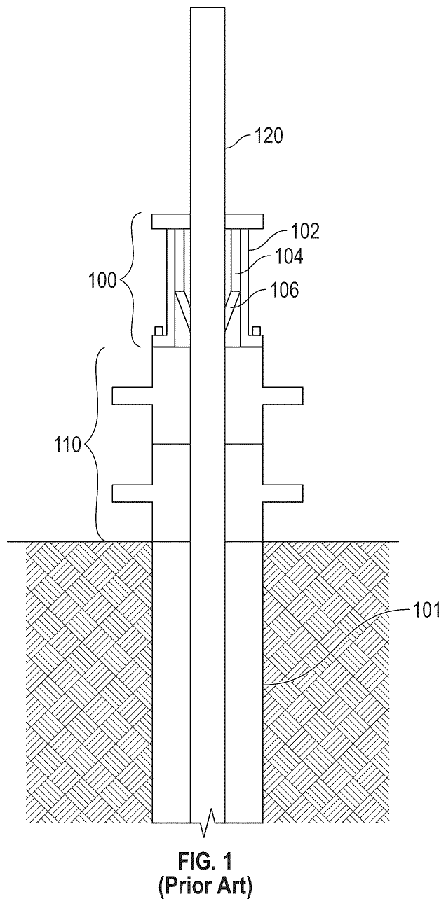

FIG. 2 shows an RCD 200 having PCD bearings according to one or more embodiments of the present disclosure positioned between an outer housing 202 and an inner housing 204. The outer housing 202 may be attached to a member of a marine drilling riser or drill-thru (for example, the BOP of FIG. 1). An annular sealing element, e.g., a scaling element 206, as shown, may also be connected to the inner housing 204. The sealing element 206 may contact and create a seal against a drill pipe (such as 120 in FIG. 1) as the drill pipe (120) is rotated (e.g., during a drilling operation). For example, a drill string inserted through the RCD 200 may be rotated by a Kelly or other assembly to rotate the inner housing 204.

The inner housing 204 is rotatably mounted within the outer housing 202 using PCD bearings, according to one or more embodiments. The PCD bearings may be included as radial PCD bearings 208, axial PCD bearings 210, and/or tapered PCD bearings (described more below) provided between the inner housing 204 and the outer housing 202. For example, in some embodiments, a combination of radial and axial PCD bearings may be provided between the inner and outer housing. In some embodiments, a combination of radial, axial, and tapered PCD bearings may be provided between an inner and outer housing. Radial PCD bearings 208 include PCD bearings positioned along an inner radial surface of the outer housing 202 and along an outer radial surface of the inner housing 204, where radial surfaces may extend in a direction parallel with a central rotational axis of the inner housing 204. The PCD radial surfaces provide a PCD radial interface between the inner housing 204 and the outer housing 202. The PCD radial interface allows the inner housing 204 to rotate relative to the outer housing 202 while also supporting radial loads between the interfacing surfaces. Similarly, the axial PCD bearings 210 include PCD bearings positioned along a lower axial surface of the inner housing 204 and an upper axial surface of the outer housing 202, where axial surfaces may extend in a direction perpendicular to the rotational axis. The PCD axial surfaces provide a PCD axial interface between the inner housing 204 and the outer housing 202. The PCD axial interface allows the inner housing 204 to rotate relative to the outer housing 202 while also supporting axial loads between the interfacing surfaces.

PCD bearings may be formed of PCD provided along one or both interfacing surfaces between any elements in an RCD, between an inner housing and an outer housing of an RCD. PCD bearings may also be provided between a sealing element and an inner housing, a sealing element and an outer housing, and/or a sealing element and another element or surface of an RCD. Additionally, PCD bearings may be formed of PCD provided directly on a surface of an inner housing and/or an outer housing, or PCD bearings may be formed of PCD provided on a bearing base ring, where the base ring may be positioned between the inner housing and the outer housing of an RCD.

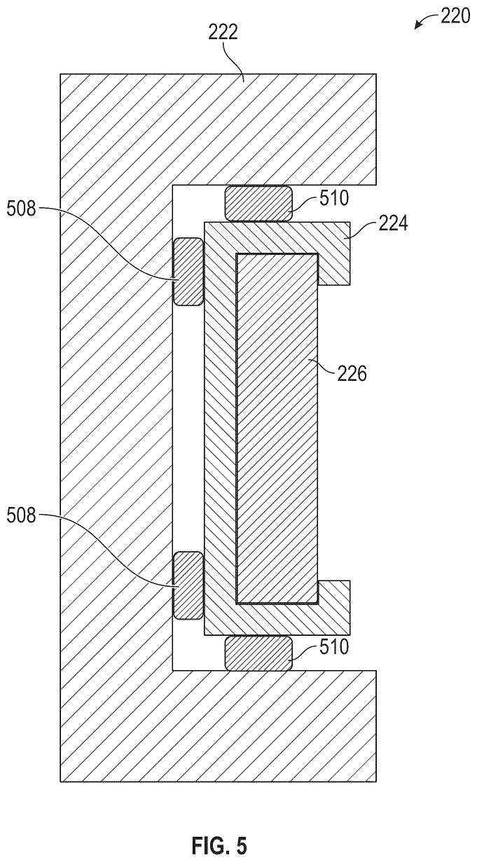

FIG. 5 shows a portion of another example of an RCD 220 having PCD bearings according to one or more embodiments of the present disclosure. The PCD bearings may be positioned in multiple locations between an outer housing 222 and an inner housing 224. The outer housing 222 may be attached to a member of a marine drilling riser or drill-thru (for example, the BOP of FIG. 1). An annular sealing element, e.g., a sealing element 226, as shown, may also be connected within the inner housing 224. The sealing element 226 may contact and create a seal against a drill pipe (e.g., by applying constricting pressure around the outer surface of the sealing element) as the drill pipe (120) is rotated (e.g., during a drilling operation). For example, a drill string inserted through the RCD 220 may be rotated by a Kelly or other assembly, which thereby rotates the inner housing 224.

In one or more embodiments, the sealing element 226 may be any annular sealing element having a sleeve-shaped body, as known in the art, which may be activated to push radially inward to contact and seal against a drill pipe.

The inner housing 224 is rotatably mounted within the outer housing 222 using PCD bearings, according to one or more embodiments. The PCD bearings may be included as radial PCD bearings 508, axial PCD bearings 510, or a combination of radial and axial bearings provided between the inner housing 224 and the outer housing 222.

Radial PCD bearings 508 include PCD positioned between an inner radial surface of the outer housing 222 and an outer radial surface of the inner housing 224, where radial surfaces may extend in a direction parallel with a central rotational axis of the inner housing 224. In some embodiments, PCD forming the radial PCD bearings 508 may be provided directly on the radial surfaces of the inner housing 224 and/or outer housing 222. In some embodiments, the PCD forming the radial PCD bearings 508 may be provided alone on radial surfaces of a separate bearing base positioned between the radial surfaces of the inner and outer housings 224, 222. In some embodiments, PCD forming the radial PCD bearings 508 may be provided on a combination of radial surfaces of the inner and/or outer housing 224, 222 and radial surfaces of a separate bearing base positioned between the radial surfaces of the inner and outer housings 224, 222.

In the embodiment shown, two sets of spaced apart radial PCD bearings 508 are provided between the inner and outer housings 224, 222, However, one or more than two sets of radial PCD bearings according to embodiments of the present disclosure may be provided between inner and outer housings 224, 222 of an RCD. In some embodiments, radial PCD bearings may be positioned in an amount and location(s) sufficient to maintain axial alignment of the inner housing 224 within the outer housing 222 as the inner housing rotates therein (e.g., by providing a uniform spacing between the inner housing 224 and outer housing 222 around the entire circumference of the inner housing 224).

The radial surfaces of the radial PCD bearings provide a PCD interface between the inner housing 224 and the outer housing 222. The PCD radial interfaces allows the inner housing 224 to rotate relative to the outer housing 222 while also supporting radial loads between the interfacing surfaces.

Axial PCD bearings 510 include PCD positioned between an axial surface of the inner housing 224 and an axial surface of the outer housing 224, where axial surfaces may extend in a direction perpendicular to the rotational axis. In some embodiments, PCD forming the axial PCD bearings 510 may be provided directly on the axial surfaces of the inner housing 224 and/or outer housing 222. In some embodiments, the PCD forming the axial PCD bearings 510 may be provided on axial surfaces of a separate bearing base positioned between the axial surfaces of the inner and outer housings 224, 222. In some embodiments, PCD forming the axial PCD bearings 510 may be provided on a combination of axial surfaces of the inner and/or outer housing 224, 222 and axial surfaces of a separate bearing base positioned between the axial surfaces of the inner and outer housings 224, 222.

In the embodiment shown, an upper axial PCD bearing 510 is provided between an upper axial surface of the inner housing 224 and a lower axial surface of the outer housing 222, and a lower axial PCD bearing 510 is provided between a lower axial surface of the inner housing 224 and an upper axial surface of the outer housing 222. According to embodiments of the present disclosure, one or more axial PCD bearings may be provided at different locations between axial surfaces of inner and outer housings 224, 222.

PCD axial surfaces of axial PCD bearings provide a PCD axial interface between the inner housing 224 and the outer housing 222. The PCD axial interface allows the inner housing 224 to rotate relative to the outer housing 222 while also supporting axial loads between the interfacing surfaces.

PCD bearings may be formed of PCD provided along one or both interfacing surfaces between any elements in an RCD, between an inner housing and an outer housing of an RCD. PCD bearings may also be provided between a sealing element and an inner housing, a sealing element and an outer housing, and/or a sealing element and another element or surface of an RCD. Additionally, PCD bearings may be formed of PCD provided directly on a surface of an inner housing and/or an outer housing, or PCD bearings may be formed of PCD provided on a bearing base ring, where the base ring may be positioned between the inner housing and the outer housing of an RCD.

As known in the art, PCD has a microstructure formed of bonded together diamond grains. PCD may be formed by sintering together diamond grains in the presence of a sintering agent such as a metallic binder or catalyst (e.g., cobalt or a metal carbide binder). In one or more embodiments, PCD bearings may have PCD provided on a bearing surface in the form of PCD segments attached to or formed in the bearing surface, where a PCD segment may be a macro-sized (visible) piece of PCD having a substantially uniform microstructure of bonded together diamond grains.

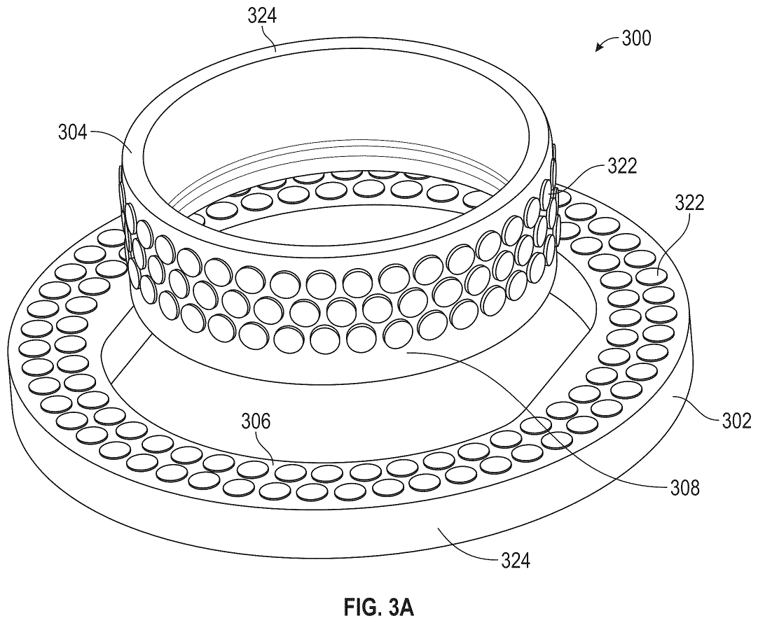

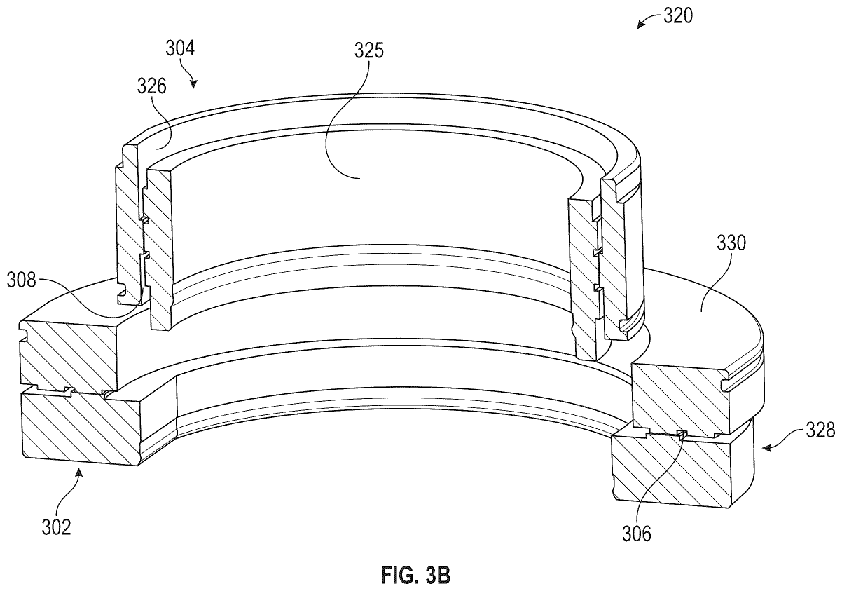

FIG. 3A shows an example of PCD bearings 300 formed of PCD provided on a base ring 324, including a radial bearing 304 and an axial bearing 302, according to one or more embodiments disclosed herein. The PCD bearings 300 each include a base ring 324 having PCD pads 322 positioned on at least one side of the base ring 324. PCD pads 322 may be PCD segments attached to a surface of the base ring 324. The PCD pads 322 may have the same shape and size, or alternatively, PCD pads 322 of different shapes and/or sizes may be provided on the base ring 324. According to embodiments of the present disclosure, a base ring 324 may be a metal ring, where PCD pads 322 may be brazed on one side (or more than one side) of the base ring 324. In embodiments having PCD pads 322 positioned on a single side of the base ring 324, the base ring 324 may be attached to an inner housing or an outer housing of an RCD by attaching a non-PCD side of the base ring 324 (e.g., a side opposite the PCD pads) to the inner or outer housing. In some embodiments, PCD pads may be positioned on opposite sides of a base ring 324, where the base ring 324 may be positioned in an un-attached manner between the inner and outer housings of an RCD.

In one or more embodiments, PCD pads 322 may be positioned along a base ring 324 in a spaced apart pattern to provide flow-by slots between the PCD pads. For example, radial flow-by slots 308 may be provided between the raised profiles of the PCD pads 322 positioned on the radial bearing 304, and axial flow-by slots 306 may be provided between the raised profiles of the PCD pads 322 positioned on the axial bearing 302. In such embodiments, the PCD bearings may be capable of having mud or other well fluids circulated through the flow-by slots, which may cool the PCD bearings as the inner housing rotates relative to the outer housing.

In some embodiments, a set of PCD embellished base rings 324 may be provided between an inner housing and an outer housing of an RCD to form PCD bearings. For example, FIG. 3B shows a cross-sectional view of a set of interfacing radial bearings (e.g., using the radial bearing 304 PCD embellished ring configuration shown in FIG. 3A) and a set of interfacing axial bearings (e.g., using the axial bearing 302 PCD embellished ring configuration shown in FIG. 3A). In the embodiment shown, PCD pads 322 are provided on interfacing surfaces of the base rings 324 in each of the radial bearings and the axial bearings. For example, in the radial bearings, PCD pads 322 may be positioned on an outer surface of an inner base ring 325 and on an inner surface of an outer base ring 326, such that the PCD pads 322 interface with each other when the outer base ring 326 is assembled around the inner base ring 325. When assembled, radial flow-by slots 308 are formed between the interfacing PCD pads 322. Similarly, in the axial bearings, PCD pads 322 may be positioned on an upper surface of a lower base ring 328 and on a lower surface of an upper base ring 330, such that the PCD pads 322 interface with each other when the upper base ring 330 is assembled on top of the lower base ring 328. When assembled, axial flow-by slots 306 are formed between the interfacing PCD pads 322.

In one or more embodiments, the PCD pads 322 may be positioned in ring patterns (or rows) along the interfacing surfaces, such as shown in FIG. 3A. The ring patterns of PCD pads may be located along a base ring to correspond with PCD pad ring patterns formed on an interfacing PCD bearing surface. For example, as shown on a lower base ring 328 of the axial bearing 302 in FIG. 3A, PCD pads 322 may be arranged in multiple rings, including an inner ring and an outer ring of PCD pads 322. An upper base ring 330 may have an inner ring and outer ring of PCD pads 322 in corresponding locations relative to an inner diameter and outer diameter of the axial bearing rings, such that when the PCD interface surface of the upper base ring 330 is assembled on and interfacing with the PCD interface surface of the lower base ring 328, the rings of PCD pads 322 may be stacked on and interface with each other as the upper base ring 330 rotates relative to the lower base ring 328. By positioning PCD pads in corresponding and interfacing rows along interfacing bearing surfaces, effective and efficient cooling may be provided by flowing fluid through the flow-by slots formed between the interfacing rows of PCD pads.

In the embodiment shown in FIG. 3B, the upper base ring 330 of the axial bearings may be attached to or integrally formed with an inner housing of an RCD, and the lower base ring of the axial bearings may be attached to or integrally formed with an outer housing of an RCD. Similarly, the inner base ring 325 of the radial bearings may be attached to or integrally formed with an inner housing of an RCD, and the outer base ring 326 may be attached to or integrally formed with an outer housing of the RCD.

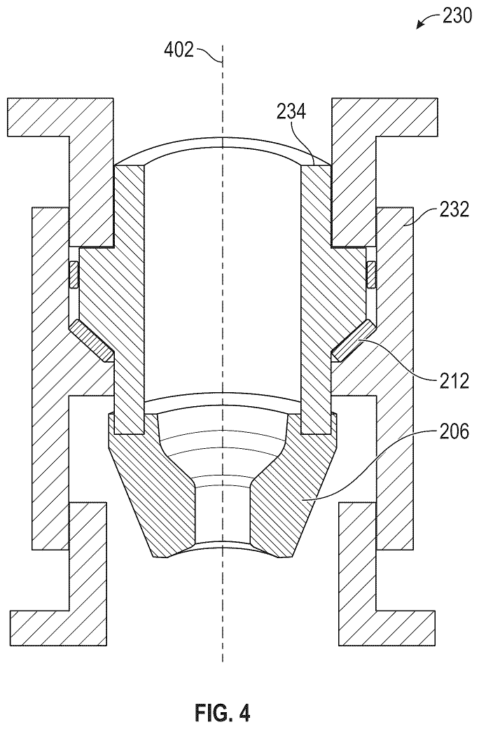

In some embodiments, such as shown in FIG. 4, a tapered PCD bearing 212 may be provided between an inner housing 234 and an outer housing 232 of an RCD 230. The tapered PDC bearing can be arranged to provide support for both radial loads (in a direction perpendicular to the RCD's rotational axis 402) and axial loads (in a direction parallel with the RCD's rotational axis 402) between the inner housing 234 and outer housing 232 of the RCD 230. In one or more embodiments, a tapered PCD bearing may be formed of two interfacing base rings 324, where the interfacing surfaces of the base rings 324 are embellished with PCD (e.g., with PCD pads as shown in the axial and radial bearings of FIGS. 3A-B, with a PCD coating, or with PCD segments embedded in the interfacing surface). In some embodiments, a tapered PCD bearing may be formed of a base ring having opposite sides interfacing with an inner housing and an outer housing of an RCD that are embellished with PCD (e.g., PCD pads, a PCD coating, or PCD segments embedded in the interfacing surfaces).

In embodiments having a set of interfacing base rings 324 provided between an inner and outer housing of an RCD, the interfacing surfaces of the base rings 324 may be embellished with PCD (e.g., PCD pads attached to an interfacing surface, a PCD coating, or PCD segments embedded in the interfacing surfaces), while one or more other sides (e.g., an opposite side from the interfacing side) may be attached to a housing component of the RCD. In embodiments having a single bearing base ring provided between an inner housing and outer housing of an RCD, opposite sides of the base ring may be embellished with PCD (e.g., PCD pads, a PCD coating, or PCD segments embedded in the interfacing surfaces), while the interfacing surfaces of the inner and outer housings may also be embellished with PCD, or the interfacing surfaces of the inner and outer housings may have a low coefficient of friction provided by a non-PCD material, such as steel, tungsten carbide, or other metal carbide composite (e.g., by polishing the interfacing surfaces).

Embodiments disclosed herein may provide one or more of the following advantages. The PCD bearings of one or more embodiments may have an extended life due to the durability of the PCD pads. The PCD bearings of one or more embodiments allows the RCD to rotate with a type of bearing (PCD) not previously used by other equipment manufacturers. The PCD bearings of one or more embodiments may have the capability to operate under well fluids and extended life as compared with other types of RCDs. Embodiments disclosed herein may be unique to the RCD as this type of bearing has not been previously used on RCDs.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A rotating control device, comprising:
an inner housing;
an outer housing; and
polycrystalline diamond bearings (PCD) positioned between the inner housing and the outer housing,
wherein the inner housing and the outer housing are rotatable relative to each other along a rotational axis via the polycrystalline diamond bearings.

2. The RCD of claim 1, wherein the PCD bearings comprise:
a plurality of radial PCD bearings formed directly on an inner radial surface of the outer housing wherein the inner radial surface of the outer housing extends in a direction parallel with a central rotational axis of the inner housing.

3. The RCD of claim 2, wherein the PCD bearings further comprise:
a plurality of radial PCD bearings formed directly on an outer radial surface of the inner housing, wherein the outer radial surface of the inner housing extends in the direction parallel with the central rotational axis of the inner housing.

4. The RCD of claim 1, wherein the PCD bearings comprise:
a plurality of radial PCD bearings formed on one or more surfaces of a bearing base ring, wherein the bearing base ring is positioned between an inner radial surface of the outer housing and an outer radial surface of the inner housing.

5. The RCD of claim 1, wherein:
at least two sets of spaced apart PCD bearings are provided between the inner housing and the outer housing;
a spacing of the PCD bearings provide radial flow-by slots between each of the at least two sets of spaced apart PCD bearings; and
the radial flow-by slots are configured to receive a well fluid, whereby receiving the well fluid provides cooling to the PCD bearings.

6. The RCD of claim 1, wherein the PCD bearings comprise:
a plurality of axial PCD bearings formed directly on a lower axial surface of the inner housing, wherein the lower axial surface of the inner housing extends in a direction perpendicular to the rotational axis.

7. The RCD of claim 6, wherein the PCD bearings further comprise:
a plurality of axial PCD bearings formed directly on an upper axial surface of the outer housing, wherein the upper axial surface of the outer housing extends in the direction perpendicular to the rotational axis.

8. The RCD of claim 1, wherein the PCD bearings comprise:
a plurality of axial PCD bearings formed on one or more surfaces of a bearing base ring, wherein the bearing base ring is positioned between a lower axial surface of the inner housing and an upper axial surface of the outer housing.

9. The RCD of claim 1, further comprising:
a sealing element connected to a portion of the inner housing; and
a plurality of PCD bearings positioned between the sealing element and the inner housing, wherein, when piping is inserted through the sealing element, a grip is provided between the sealing element and the piping providing rotation of the sealing element with the piping, and thereby also providing rotation of the sealing element connected to the portion of the inner housing and rotation of the piping sealed by the sealing element within the outer housing.

10. The RCD of claim 1, further comprising:
a sealing element connected to a portion of the inner housing; and
a plurality of PCD bearings positioned between the sealing element and the outer housing,

11. The RCD of claim 1, wherein the PCD bearings are formed on a set of bearing base rings, wherein the set of bearing base rings comprises:
an inner base ring having radial PCD bearings formed on an outer surface of the inner base ring;
an outer base ring having radial PCD bearings formed on an inner surface of the outer base ring, wherein the radial PCD bearings formed on the inner surface of the outer base ring and the radial PCD bearings formed on the outer surface of the inner base ring are configured to interface when the outer base ring is assembled around the inner base ring;
a lower base ring having axial PCD bearings formed on an upper surface of the lower base ring;
and an upper base ring having axial PCD bearings formed on a lower surface of the upper base ring, wherein the axial PCD bearings formed on the upper surface of the lower base ring and the axial PCD bearings formed on the upper surface of the lower base ring are configured to interface with each other when the upper base ring is assembled on the upper surface of the lower base ring.

12. The RCD of claim 11, wherein, when the outer base ring is assembled around the inner base ring, a radial PCD bearing interface provides radial flow-by slots, wherein the radial flow-by slots are configured to receive a well fluid, whereby receiving the well fluid provides cooling to the PCD bearings.

13. The RCD of claim 11, wherein, when the upper base ring is assembled on the upper surface of the lower base ring, an axial PCD bearing interface provides axial flow-by slots, wherein the axial flow-by slots are configured to receive a well fluid, whereby receiving the well fluid provides cooling to the PCD bearings.

14. The RCD of claim 1, wherein the PCD bearings comprise:
a plurality of tapered PCD bearings positioned along an inner surface of the outer housing and along an outer surface of the inner housing, wherein the tapered PCD bearings are positioned to provide support for both radial loads and axial loads between the inner housing and the outer housing.

15. The RCD of claim 14, wherein the tapered PCD bearings are formed directly on the inner surface of the outer housing and the outer surface of the inner housing.

16. The RCD of claim 15, wherein the tapered PCD bearings are formed on one or more surfaces of a bearing base ring, wherein the bearing base ring is positioned between the inner surface of the outer housing and the outer surface of the inner housing.

17. A device, comprising:
a set of bearing base rings, wherein the set of bearing base rings comprises:
an inner base ring having a plurality of radial polycrystalline diamond (PCD) bearings formed on an outer surface of the inner base ring;
a lower base ring having a plurality of axial PCD bearings formed on an upper surface of the lower base ring.

18. The device of claim 17, wherein the set of bearing base rings further comprises:
an outer base ring having radial PCD bearings formed on an inner surface of the outer base ring, wherein the radial PCD bearings formed on the inner surface of the outer base ring and the radial PCD bearings formed on the outer surface of the inner base ring are configured to interface when the outer base ring is assembled around the inner base ring; and
an upper base ring having axial PCD bearings formed on a lower surface of the upper base ring, wherein the axial PCD bearings formed on the upper surface of the lower base ring and the axial PCD bearings formed on the upper surface of the lower base ring are configured to interface with each other when the upper base ring is assembled on the upper surface of the lower base ring.

19. The device of claim 18, wherein:
the radial PCD bearings further comprises at least two sets of spaced apart radial PCD bearings, wherein a spacing between the plurality of radial PCD bearings provides radial flow-by slots between each of the at least two sets of spaced apart radial PCD bearings, and wherein the radial flow-by slots are configured to receive a well fluid, whereby receiving the well fluid provides cooling to the radial PCD bearings; and
the axial PCD bearings further comprises at least two sets of spaced apart axial PCD bearings, wherein a spacing between the plurality of axial PCD bearings provides axial flow-by slots between each of the at least two sets of spaced apart axial PCD bearings, and wherein the axial flow-by slots are configured to receive a well fluid, whereby receiving the well fluid provides cooling to the axial PCD bearings.

20. The device of claim 17, wherein the set of bearing base rings are configured to provide rotation between one or more portions of a rotating control device (RCD) via rotation about the radial PCD bearings or the axial PCD bearings.
